(19) United States
(12) Patent Application Publication
(10) Pub. No.: US 2006/0129758 A1
(43) Pub. Date: Jun. 15, 2006

(54) Zero channel raid architecture

(75) Inventors: Bruce Ray Trunck, Monument, CO (US); Christopher John McCarty, Colorado Springs, CO (US)

Correspondence Address: LSI LOGIC CORPORATION, 1621 BARBER LANE, MS: D-106, MILPITAS, CA, 95035, US

(73) Assignee: LSI Logic Corporation

(21) Appl. No.: 11/010,464

(22) Filed: Dec. 13, 2004

(51) Int. Cl. G06F 12/14

(52) U.S. Cl. 711/114

(57) ABSTRACT

A computer system motherboard includes connection points for receiving a processor and a disk controller card. At least one communication bus connects the processor and the disk controller card. Another connection point is provided between the processor and the disk controller card for receiving one of a jumper or a card that includes RAID controller circuitry. The processor executes a device discovery process and selectively loads RAID device drivers in response to the discovery of a card that includes RAID controller circuitry.

### TECHNICAL FIELD

The described subject matter relates to electronic computing, and more particularly to a zero channel RAID architecture.

### BACKGROUND

Conventional computing systems that implement RAID data protection include a disk controller card that includes disk controller circuitry and RAID circuitry. Such disk controller cards are typically implemented as cards that plug into corresponding slots on a motherboard.

### BRIEF DESCRIPTION OF THE DRAWINGS

FIG. 1 is a schematic illustration of an exemplary implementation of a computing device.

FIG. 2 is a schematic illustration of an exemplary implementation of components on a motherboard for use in a computing device.

FIG. 3 is a schematic illustration of an exemplary implementation of a computing device that can be utilized to implement a host.

### DETAILED DESCRIPTION

Described herein are exemplary architectures and methods for implementing zero channel RAID in a computing device such as, e.g., a personal computer. The methods described herein may be embodied as logic instructions on a computer-readable medium. When executed on a processor, the logic instructions cause a general purpose computing device to be programmed as a special-purpose machine that implements the described methods. The processor, when configured by the logic instructions to execute the methods recited herein, constitutes structure for performing the described methods.

Exemplary Computing Device

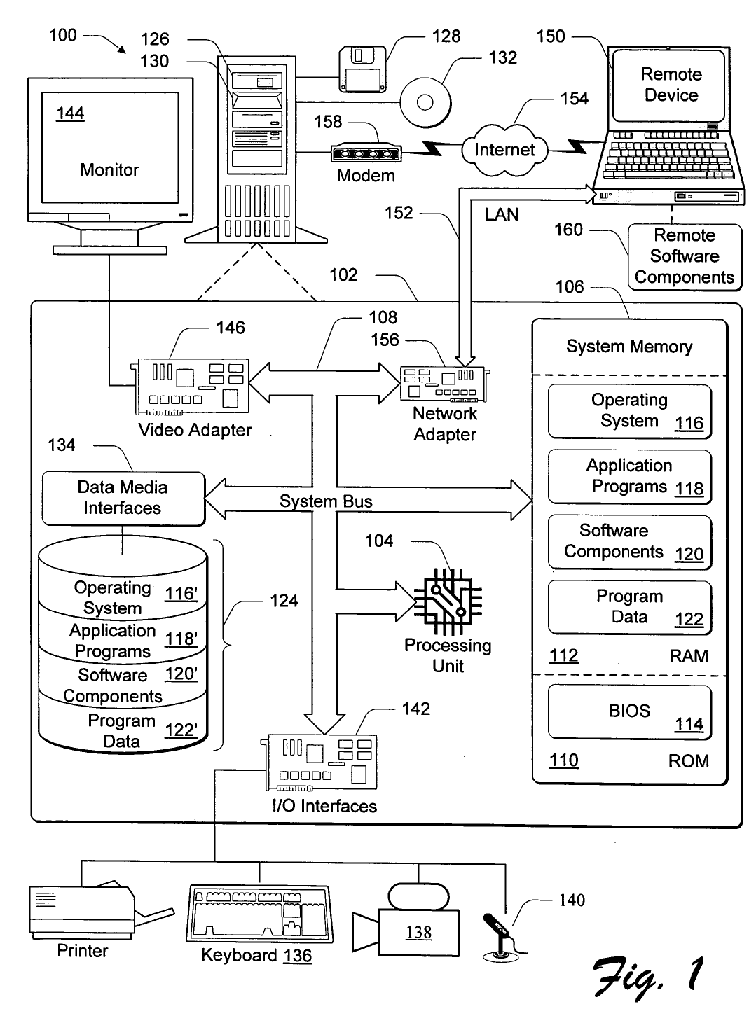

The various components and functionality described herein are implemented with a number of individual computers. FIG. 1 shows components of typical example of such a computer, referred by to reference numeral 100. The components shown in FIG. 1 are only examples, and are not intended to suggest any limitation as to the scope of the functionality of the invention; the invention is not necessarily dependent on the features shown in FIG. 1.

Generally, various different general purpose or special purpose computing system configurations can be used. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The functionality of the computers is embodied in many cases by computer-executable instructions, such as program modules, that are executed by the computers. Generally, program modules include routines, programs, objects, components, data structures, etc. that performs particular tasks or implement particular abstract data types. Tasks might also be performed by remote processing devices that are linked through a communications network. In a distributed computing environment, program modules may be located in both local and remote computer storage media.

The instructions and/or program modules are stored at different times in the various computer-readable media that are either part of the computer or that can be read by the computer. Programs are typically distributed, for example, on floppy disks, CD-ROMs, DVD, or some form of communication media such as a modulated signal. From there, they are installed or loaded into the secondary memory of a computer. At execution, they are loaded at least partially into the computer's primary electronic memory. The invention described herein includes these and other various types of computer-readable media when such media contain instructions programs, and/or modules for implementing the steps described below in conjunction with a microprocessor or other data processors. The invention also includes the computer itself when programmed according to the methods and techniques described below.

For purposes of illustration, programs and other executable program components such as the operating system are illustrated herein as discrete blocks, although it is recognized that such programs and components reside at various times in different storage components of the computer, and are executed by the data processor(s) of the computer.

With reference to FIG. 1, the components of computer 100 may include, but are not limited to, a processing unit 104, a system memory 106, and a system bus 108 that couples various system components including the system memory to the processing unit 104. The system bus 108 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISAA) bus, Video Electronics Standards Association (VESA) local bus, and Peripheral Component Interconnect (PCI) bus also known as the Mezzanine bus.

Computer 100 typically includes a variety of computer-readable media. Computer-readable media can be any available media that can be accessed by computer 100 and includes both volatile and nonvolatile media, removable and non-removable media. By way of example, and not limitation, computer-readable media may comprise computer storage media and communication media. “Computer storage media” includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer-readable instructions, data structures, program modules or other data in a modulated data signal such as a carrier wave or other transport mechanism and includes any information delivery media. The term “modulated data signal” means a signal that has one or more if its characteristics set or changed in such a manner as to encode information in the signal. By way of example, and not limitation, communication media includes wired media such as a wired network or direct-wired connection and wireless media such as acoustic, RF, infrared and other wireless media. Combinations of any of the above should also be included within the scope of computer readable media.

The system memory 106 includes computer storage media in the form of volatile and/or nonvolatile memory such as read only memory (ROM) 110 and random access memory (RAM) 112. A basic input/output system 114 (BIOS), containing the basic routines that help to transfer information between elements within computer 100, such as during start-up, is typically stored in ROM 110. RAM 112 typically contains data and/or program modules that are immediately accessible to and/or presently being operated on by processing unit 104. By way of example, and not limitation, FIG. 1 illustrates operating system 116, application programs 118, other program modules 120, and program data 122.

The computer 100 may also include other removable/non-removable, volatile/nonvolatile computer storage media. By way of example only, FIG. 1 illustrates a hard disk drive 124 that reads from or writes to non-removable, nonvolatile magnetic media, a magnetic disk drive 126 that reads from or writes to a removable, nonvolatile magnetic disk 128, and an optical disk drive 130 that reads from or writes to a removable, nonvolatile optical disk 132 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 124 is typically connected to the system bus 108 through a non-removable memory interface such as data media interface 134, and magnetic disk drive 126 and optical disk drive 130 are typically connected to the system bus 108 by a removable memory interface 134.

The drives and their associated computer storage media discussed above and illustrated in FIG. 1 provide storage of computer-readable instructions, data structures, program modules, and other data for computer 100. In FIG. 1, for example, hard disk drive 124 is illustrated as storing operating system 116′, application programs 118′, other program modules 120′, and program data 122′. Note that these components can either be the same as or different from operating system 116, application programs 118, other program modules 120, and program data 122. Operating system 116, application programs 118, other program modules 120, and program data 122 are given different numbers here to illustrate that, at a minimum, they are different copies. A user may enter commands and information into the computer 100 through input devices such as a keyboard 136, a mouse, trackball, or touch pad. Other input devices (not shown) may include a microphone, joystick, game pad, satellite dish, scanner, or the like. These and other input devices are often connected to the processing unit 104 through an input/output (I/O) interface 142 that is coupled to the system bus, but may be connected by other interface and bus structures, such as a parallel port, game port, or a universal serial bus (USB). A monitor 144 or other type of display device is also connected to the system bus 108 via an interface, such as a video adapter 146. In addition to the monitor 144, computers may also include other peripheral output devices (e.g., speakers) and one or more printers, which may be connected through the I/O interface 142.

The computer may operate in a networked environment using logical connections to one or more remote computers, such as a remote computing device 150. The remote computing device 150 may be a personal computer, a server, a router, a network PC, a peer device or other common network node, and typically includes many or all of the elements described above relative to computer 100. The logical connections depicted in FIG. 1 include a local area network (LAN) 152 and a wide area network (WAN) 154. Although the WAN 154 shown in FIG. 1 is the Internet, the WAN 154 may also include other networks. Such networking environments are commonplace in offices, enterprise-wide computer networks, intranets, and the like.

When used in a LAN networking environment, the computer 100 is connected to the LAN 152 through a network interface or adapter 156. When used in a WAN networking environment, the computer 100 typically includes a modem 158 or other means for establishing communications over the Internet 154. The modem 158, which may be internal or external, may be connected to the system bus 108 via the I/O interface 142, or other appropriate mechanism. In a networked environment, program modules depicted relative to the computer 100, or portions thereof, may be stored in the remote computing device 150. By way of example, and not limitation, FIG. 1 illustrates remote application programs 160 as residing on remote computing device 150. It will be appreciated that the network connections shown are exemplary and other means of establishing a communications link between the computers may be used.

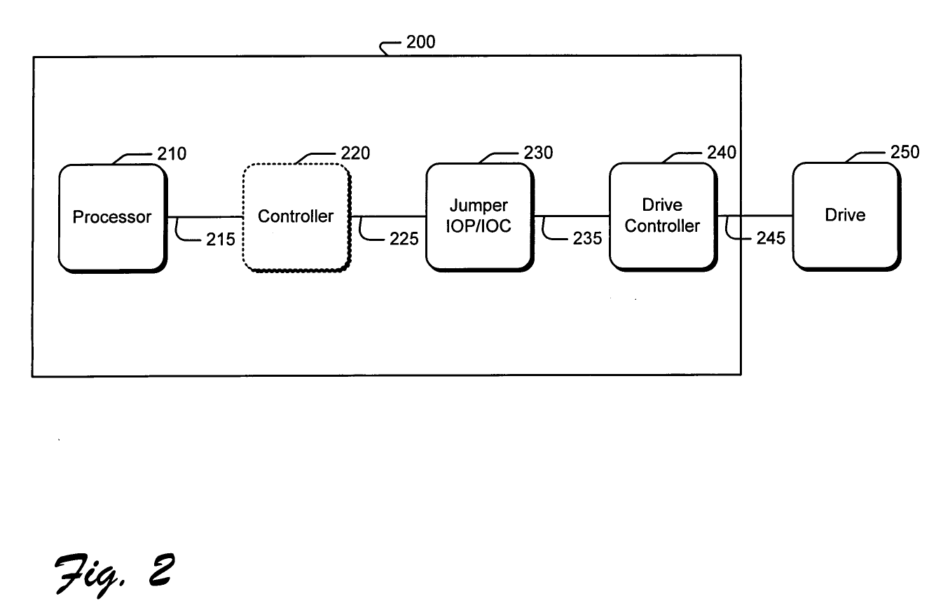

FIG. 2 is a schematic illustration of an exemplary implementation of components on a motherboard 200 which may be used in a computing device such as, e.g., a personal computer or a server. The particular configuration of the motherboard is not important to the subject matter described and claimed herein. FIG. 2 illustrates select components of interest; it will be appreciated that the motherboard includes additional components not illustrated in FIG. 2. The motherboard includes slots for receiving a processor 210 and an optional controller 220 such as, e.g., a Northbridge chipset. Motherboard further includes a slot for receiving a drive controller 240 that provides an interface with and controls operations of a drive 250. The particular configurations of the drive controller and/or the drive are not important to the subject matter described and claimed herein. Conventional drive controllers 240 are implemented as plug-in cards commercially available from a wide variety of manufacturers. The various components illustrated in FIG. 2 are connected by a suitable interconnects 215, 225, 235, 245. In one exemplary implementation two or more interconnects are implemented as PCI Express interconnects.

Motherboard 200 further includes a slot in the communication path between the processor 210 and the drive controller 240 for receiving one a card 230 that includes either a jumper or a card comprising control circuitry for implementing RAID data protection on drive 250. In an exemplary implementation the control circuitry may be implemented using a dedicated Input/Output Processor (IOP) that implements RAID data protection. In an alternate implementation the control circuitry may be implemented using a configurable Input/Output Controller (IOC) that implements RAID data protection. The particular level of RAID data protection implemented is not important.

In one aspect, providing a separate slot on motherboard 200 for receiving a card 230 comprising either a jumper or RAID circuitry permits RAID functionality to be implemented separately from disk control functions. Computer system manufacturers can selectively implement RAID systems in accordance with consumer requests. A system that implements a card 230 that comprises a jumper lacks RAID functionality. By contrast, a system implements a card 230 that comprises either an IOP or an IOC implements RAID functionality.

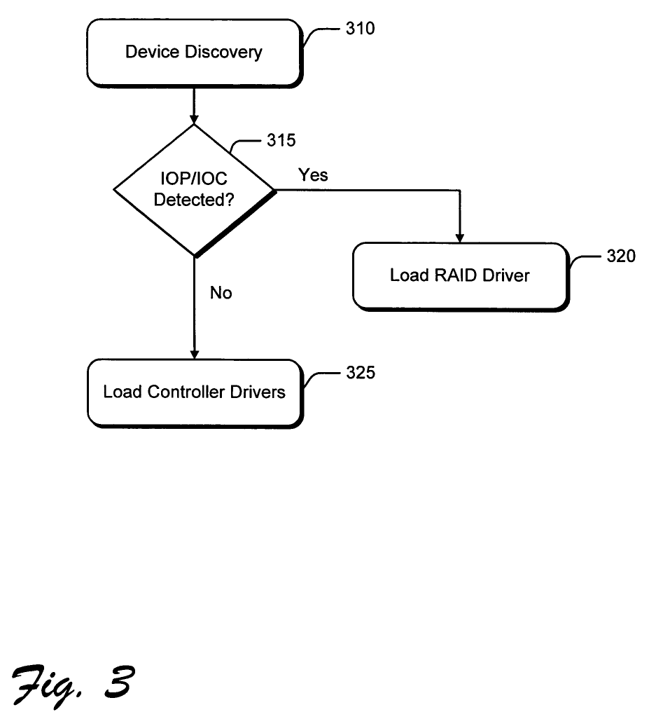

FIG. 3 is a flowchart illustrating operations 300 implemented by processor 210 on motherboard 200 during an initialization or start-up process. At operation 310 processor 210 implements a device discovery process, e.g., as part of the BIOS startup. If, during the device discovery process 310, processor 210 detects an IOP or an IOC (operation 315), the processor loads RAID drivers (operation 320) for interfacing with the IOP or IOC. The IOP or IOC may subsequently load controller drivers on its processor. By contrast, if neither and IOP nor an IOC is detected at operation 315, then control passes directly to operation 325 and the processor loads controller drivers. The RAID and controller drivers may be stored in a suitable memory location associated with processor 210.

The function performed by the flow diagram of FIG. 3 may be implemented using a conventional general purpose digital computer programmed according to the teachings of the present specification, as will be apparent to those skilled in the relevant art(s). Appropriate software coding can readily be prepared by skilled programmers based on the teachings of the present disclosure, as will also be apparent to those skilled in the relevant art(s).

Although the described arrangements and procedures have been described in language specific to structural features and/or methodological operations, it is to be understood that the subject matter defined in the appended claims is not necessarily limited to the specific features or operations described. Rather, the specific features and operations are disclosed as preferred forms of implementing the claimed present subject matter.

What is claimed is:

1. A method of computing, comprising:
detecting, during a device discovery process, at least one of a disk controller and RAID control circuitry; and
selectively loading one or more RAID drivers when RAID control circuitry is detected.

2. The method of claim 1, wherein detecting, during a device discovery process, at least one of a disk controller and RAID control circuitry comprises at least one of an IOP or an IOC.

3. The method of claim 1, wherein detecting, during a device discovery process, at least one of a disk controller and RAID control circuitry comprises executing a BIOS system.

4. The method of claim 1, wherein selectively loading one or more RAID drivers when RAID control circuitry is detected comprises retrieving the one or more RAID drivers from a suitable memory location.

5. The method of claim 1, further comprising loading one or more drive controller drivers.

6. A computing system, comprising:
a processor;
a drive controller;
one or more drives;
a motherboard including at least one communication bus for providing a communication path between the processor, the drive controller, and the one or more drives; and
a connection point in a communication path between the processor and the drive controller and configured to receive a card that includes either a jumper or circuitry for implementing RAID functionality on the one or more drives.

7. The computing system of claim 6, wherein the circuitry for implementing RAID functionality on the one or more drives comprises at least one of an IOP or an IOC.

8. The computing system of claim 6, wherein the at least one communication bus comprises a PCI express bus.

9. The computing system of claim 6, further comprising:
a memory module communicatively connected to the processor; and
logic instructions in the memory module which, when executed by the processor, configure the processor to detect circuitry for implementing RAID functionality on the one or more drives; and in response thereto to load RAID drivers from the memory module.

10. The computing system of claim 9, wherein the logic instructions comprise firmware.

11. A motherboard for a computing system, comprising:
a first connection point for receiving a processor;
a second connection point for receiving a disk controller;
at least one communication bus between the processor and the disk controller;
a third connection point in the communication path between the processor and the drive controller and configured to receive a card that includes either a jumper or circuitry for implementing RAID functionality on the one or more drives.

12. The motherboard of claim 11, wherein the at least one communication bus comprises a PCI express bus.
